(19) United States
(12) Patent Application Publication
(10) Pub. No.: US 2004/0039726 A1
(43) Pub. Date: Feb. 26, 2004

(54) Information providing system for contents embedded with identifier

(75) Inventors: Hidenori Shimizu, Tokyo (JP); Taro Sugahara, Tokyo (JP); Fumitoshi Ukai, Tokyo (JP); Hironori Bouno, Tokyo (JP); Kei Yuasa, Mountain View, CA (US); Shinya Nakagawa, Tokyo (JP); Motohiro Machida, Tokyo (JP); Toshiki Iso, Kanagawa (JP); Masaji Katagiri, Kanagawa (JP); Toshiaki Sugimura, Kanagawa (JP); Marc McEachern, Tokyo (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignees: NTT DoCoMo, Inc., Tokyo (JP); HEWLETT-PACKARD COMPANY, Palo Alto, CA

(21) Appl. No.: 10/435,829

(22) Filed: May 12, 2003

(30) Foreign Application Priority Data
May 13, 2002 (JP) 2002-137350

(51) Int. Cl. G06F 7/00

(52) U.S. Cl. 707/1

(57) ABSTRACT

The system comprises a terminal apparatus that views or plays the content acquired from a data provider which embeds an identifier to the content. The system comprises a database for storing information tickets for each of the identifiers. The terminal apparatus captures the identifier embedded in the content. The system further comprises a service portal that, in response to the identifier which has been captured by and transmitted from the terminal apparatus over the Internet, searches the database and provides a service for connecting the terminal apparatus to a web page associated with the identifier.

### BACKGROUND OF THE INVENTION

The present invention relates to a system which embeds into an image data to be provided to a user an identifier for the object related with the image data so as to provide the information to the user indirectly through the identifier.

Conventionally, information to the users via media such as advertisements has been provided directly to the viewers. Accordingly, the viewers are forced to view such information even if they have no interest in it, which sometimes results in disturbing the viewers from viewing the media comfortably.

Therefore, there exists a need for a system in which such information as advertisements or the like is presented to a viewer in accordance with the viewer's intention.

### SUMMARY OF THE INVENTION

A system that is provided, according to one aspect of the present invention, comprises an audio-visual apparatus for viewing the content of the data acquired from a data provider, which embeds an identifier associated with the data into the data. Besides, the system comprises a database for storing one or more information tickets for each of the identifiers. The audio-visual apparatus is configured to read the identifier embedded in the data. The system further comprises a service portal, which, in response to the identifier read and sent from the audio-visual apparatus or a terminal apparatus over the Internet, searches the database and provides a service to the user including connecting the audio-visual apparatus or the terminal apparatus to a Web page corresponding to the identifier.

According to another aspect of the invention, the service portal provides to the audio-visual apparatus or the terminal apparatus of the user such service information as a telephone or fax number for inquiries instead of connecting the audio-visual apparatus or the terminal apparatus of the user to the Web page.

According to a further aspect of the invention, the terminal apparatus is capable of connecting to the Internet and can be integrated with the audio-visual apparatus or can be a standalone apparatus. According to yet another aspect of the invention, the audio-visual apparatus is a personal computer, a mobile apparatus or a cell phone comprising a browser.

According to yet another aspect of the invention, the portal service includes a user profile database for storing profiles of the users. The service portal reads from the user profile database the profile of the user who has transmitted the identifier and checks such profile with the information contained in the multiple information tickets so as to select the information ticket that is most appropriate to the user.

According to yet another aspect of the invention, the embedded identifier is associated with the information ticket that is linked to an advertisement related with the content of the data. According to yet another aspect of the invention, the data providing device appends a media identifier to the identifier related with the data.

### BRIEF DESCRIPTION OF THE DRAWINGS

FIG. 1 is a block diagram showing an overall structure of a UOI system as a base of the present invention.

FIG. 2 schematically illustrates a format of an information ticket.

FIG. 3 schematically illustrates a series of screens in a mobile apparatus in the system shown in FIG. 1.

FIG. 4 is a flowchart of a process for dynamically generating the screen 43 shown in FIG. 3.

FIG. 5 is a block diagram showing an overall structure of one embodiment of the invention.

FIG. 6 schematically illustrates a series of screens displayed in an audio-visual apparatus in the system shown in FIG. 4.

FIG. 7 is a flowchart of a process in which the service portal generates a menu to be presented to a user according to one embodiment of the invention.

### DESCRIPTION OF THE PREFERRED EMBODIMENTS

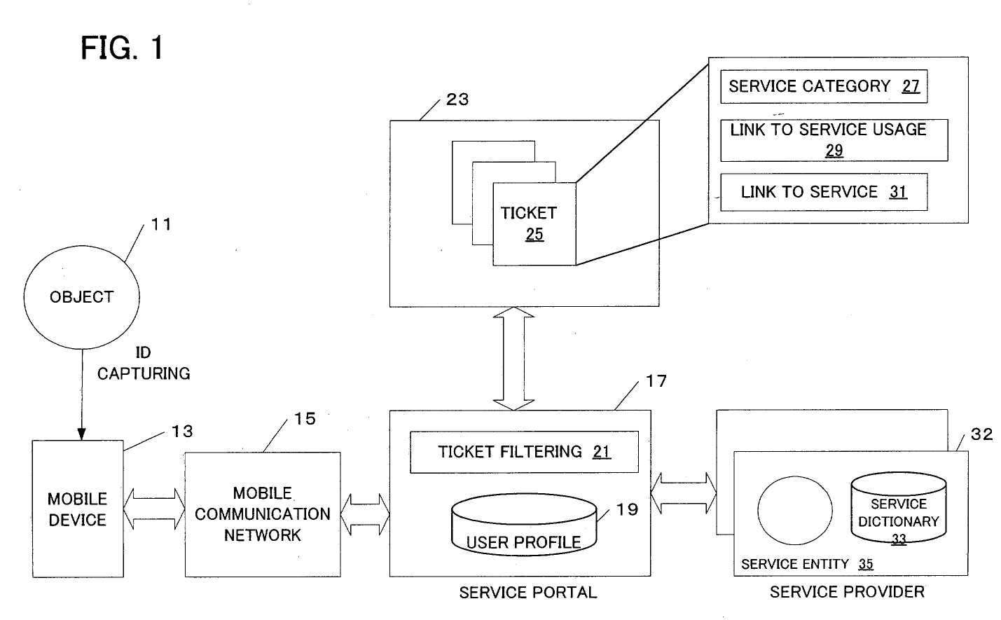

Referring now to the accompanying drawings, embodiments of the present invention will be described. FIG. 1 is a block diagram illustrating an information service system using information tickets 25 which constitues the basis of one aspect of the present invention. The details of the information service system are described in a Japanese Patent Application No. 2002-109629 assigned to the same assignees of this patent application.

Recently, many commodities are assigned respective identifiers (IDs) to be used for their sales management, inventory control and so on. The ID is typically printed on a label of the commodity in a barcode format. Although an object to which a certain ID is assigned is usually a physical, or tangible object, it may sometimes be a virtual, or intangible one. Therefore, the term “object” in this specification is refer to any object, either tangible or intangible, to which a certain ID is to be assigned. Besides, an ID that is assigned and unique to a certain object is referred to as a “Unique Object Identifier” (UOI).

A service portal 17 is provided with a user profile database 19 which stores the profiles of the users using the information service system. An information ticket database 23 stores information tickets 25 with UOIs as their keys. Each of the information tickets 25 contains link information 31 indicating appropriate links to service providers 32 which provide respective services about the object identified by the UOI. This link information 31 typically contains the URL of the page of a Web site which is an entry to the particular service provided by each of the service providers.

The information ticket includes service category description 27 and link to service usage 29. The service usage includes description of the communication protocol required for using the particular service provided by a service provider 32. This service usage is contained in a service dictionary 33 of a service provider 32. A link 29 to such service usage is embedded in each information ticket 25.

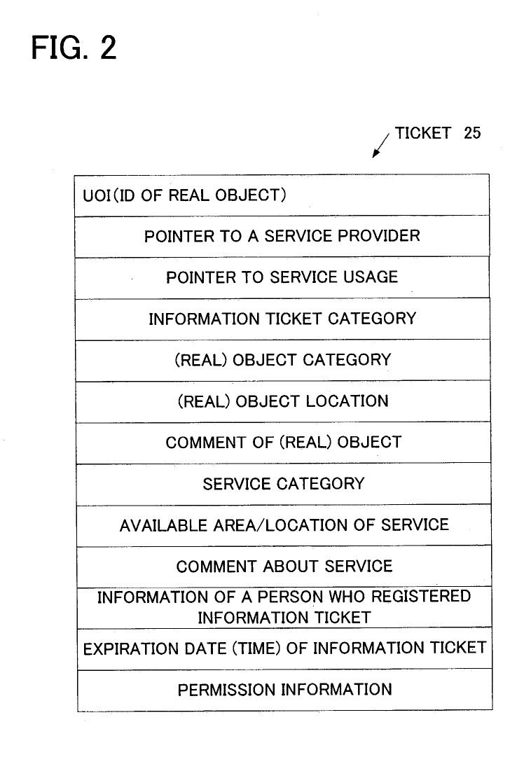

FIG. 2 is an exemplary format of the information ticket. The first field contains a UOI, the second field contains a pointer to a service provider and the third filed contains a pointer to service usage. Alternatively, the third field may directly contain the service usage itself. The forth and subsequent fields may include useful information for a user to select an information ticket appropriate to the user. For example, the “object location” and the “available area/location of service” may be used to look up the address or the business location of the user contained in the user profile.

The pointer to the service usage leads the user to such service usage forms as a web page access, an automatic telephone answer and so on. According to another embodiment, the service usage may include description of, for example, the scheme of a remote procedure call, the name of a procedure (procedure or function), the number of arguments and/or argument type, the type of the returned value, the explanation of the effect of the procedure execution (for example, the sum of the first and second arguments will be returned) and so on.

A user may read into a mobile apparatus 13 the UOI attached to an object. UOI may be represented in a barcode form which can be read by the use of a barcode reader. The user may transmit the UOI to a service portal 17 via a communication network 17. In one embodiment of the system, the user is pre-registered in the service portal 17, so that user profile including gender, age, address, business location, taste and so on is stored in the user profile database 19. In this case, when the user accesses the service portal 17, the user ID and password are transmitted to the service portal 17.

In response to the user ID and password as well as UOI transmitted from the user, the service portal 17 retrieves the user profile corresponding to the user ID from the user profile database 19 and also retrieves at least one information ticket 25 corresponding to this UOI from the information ticket database 23. The database 23 may be located within the service portal 17, or alternatively the service portal 17 may communicate with the database 23 over the network when the database is located at a remote location. When there are multiple information tickets 25 for one UOI, all corresponding information tickets are retrieved.

A ticket filtering unit 21 checks those multiple information tickets 25 with the user profile of the user and selects one information ticket appropriate to the user. When selecting the information ticket appropriate to the user, the ticket filtering unit 21 verifies whether or not the service usage of the service provider 32 indicted on the information ticket 25 fits the mobile apparatus 13 of the user.

After the information ticket 25 appropriate to the user has been selected, the service portal 17 uses a link to the service contained in that information ticket 25 to connect the mobile apparatus 13 of the user to a service entity 35 of the service provider 32. Since a link to the URL of the particular page of the Web site of the service provider 32 is typically embedded in the information ticket 25, the page of such URL is transmitted to the mobile apparatus 13.

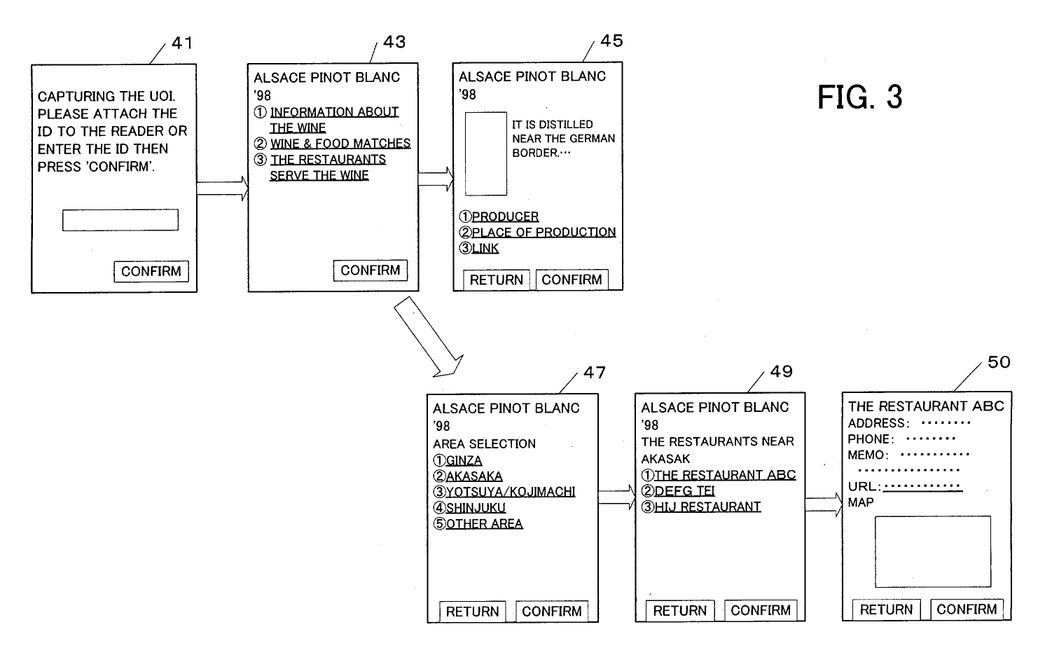

FIG. 3 shows an example of the information to be displayed in the screen of the mobile apparatus 13. Now, assume a case in which a user reads a barcode of a label attached on a bottle of wine by the use of a barcode reader. When the user operates the user's mobile apparatus 13 to select a UOI-reading mode in accordance with the system, such screen as shown in a frame 41 is displayed. When the user reads the barcode of the label with the barcode reader connected to the mobile apparatus, the UOI is displayed in a rectangle within the frame 41. When the user depresses a decision button, the UOI is transmitted to the service portal 17. The service portal 17 receives the user ID as well as the UOI of the object for which the user wants a service. In response, the service portal 17 provides the user with the information for connecting to the corresponding service provider, or dynamically generates a menu screen which is presented to the user for guiding the user into a service that the user chooses from the menu.

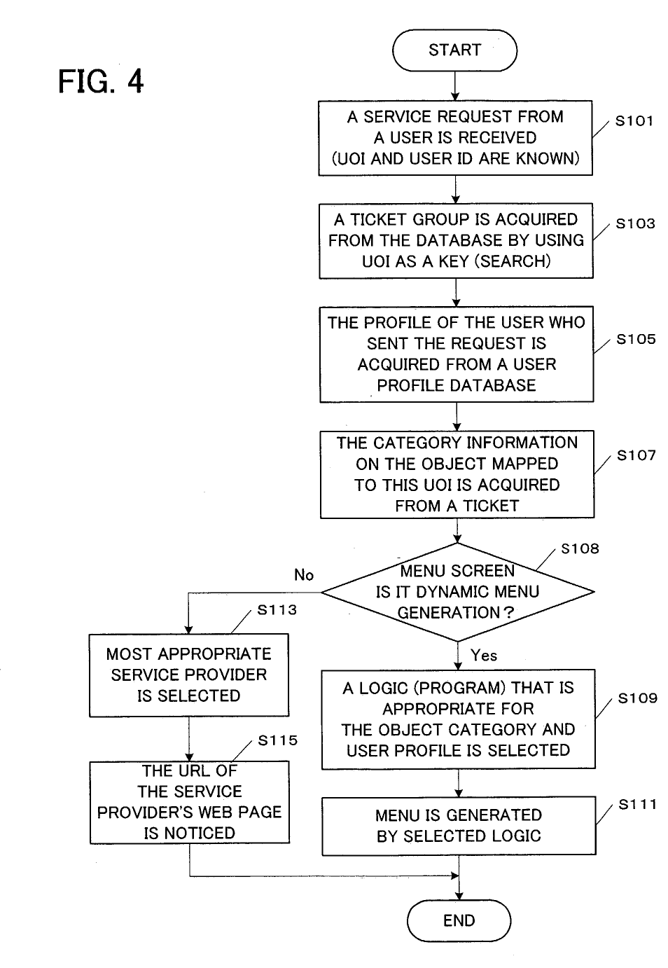

FIG. 3 shows a menu screen 43 which the service portal 17 dynamically generates according to a service request from a user and provides to the user. FIG. 4 shows a flowchart of a process in which the service portal 17 dynamically generates the menu screen 43. When the service portal 17 receives a UOI from a user as a service request (S101), the service portal 17 searches the ticket database using the UOI as a key and obtains a group of corresponding tickets (S103). In parallel, the service portal 17 searches the user profile database using the user ID of the user as a key to the profile of the user who has transmitted the request (S105). The service portal 17 extracts the category of the object from the information tickets acquired in step S103 (S107). In this example, the object is a specific bottle of German wine and the category is wine.

Then, the process proceeds to step S108, in which the service portal 17 looks up a pre-set table to determine whether or not the extracted category is set as a target of dynamically generating the menu screen (S108). In the present case, wine is set as a target of dynamic generation of the menu screen. Accordingly, the process proceeds to step S109, in which the service portal 17 selects a menu generation logic (program) which conforms to the category of the object as well as the user profile acquired in step S105 (S109).

In the present example, it is assumed that users are general consumers. The service portal 17 selects the menu generation logic for the general consumers. This logic presents menu items including “information about the wine”, “dishes matching the wines” and “restaurants serving wines”. The service portal 17 selects the information tickets of the service providers which provide the “information about the wine” from the group of the tickets extracted in step S103 and adds respective links to the menu. Similarly, the service portal 17 selects the information tickets of the service providers which provide the “dishes matching the wine” and adds respective links to the menu. Further, the service portal 17 selects the information tickets of the service providers which provide “restaurants serving the wine” and adds respective links to the menu. Thus, the screen 43 shown in FIG. 3 is generated and transmitted to the mobile apparatus of the user and is displayed there (S111).

When the user selects the “information about the wine” and depresses the decision button in the screen 43, the browser of the user is connected to a web page of the service provider to which a link is established in the selected item in the screen 43. The Web page is displayed in the user's terminal as shown in the screen 45. When the user selects “restaurants serving the wine” and depresses the decision button in the screen 43, the browser is connected to a web page of the service provider to which a link is established in the screen 43. The Web page is displayed in the user's terminal as shown in the screen 47.

When, in step S108 of FIG. 4, the category of the object is not set as a target of the dynamic generation of the menu screen, the service portal 17 selects the ticket which is most appropriate for the user's profile from the group of tickets acquired in step S103 (S113) and informs the URL of the web page to the user (S115). The service portal 17 may be configured to connect the user directly to this URL.

There are some embodiments for providing services to users. For example, in one embodiment, a telephone number is provided for users to contact a specific mail order service.

In another embodiment, the information indicating the current location of the user can be transmitted when the user transmits the UOI to the service portal. The positional information can be transmitted to the service portal by means of, for example, the positional information service using a Personal Handyphone System, known as PHS. For the details, reference may be made to http://www.nttdocomo.co.jp/mc-user/phs/ichi. Or the positional information may be transmitted by means of gpsOne technology of Qualcomm Inc., USA. In one embodiment utilizing such positional information, the user may transmit its positional information together with the UOI for a cigarette to the service portal 17. In return, the service portal 17 presents the user with the information about a store or a vending machine selling such cigarette, which is located near the user.

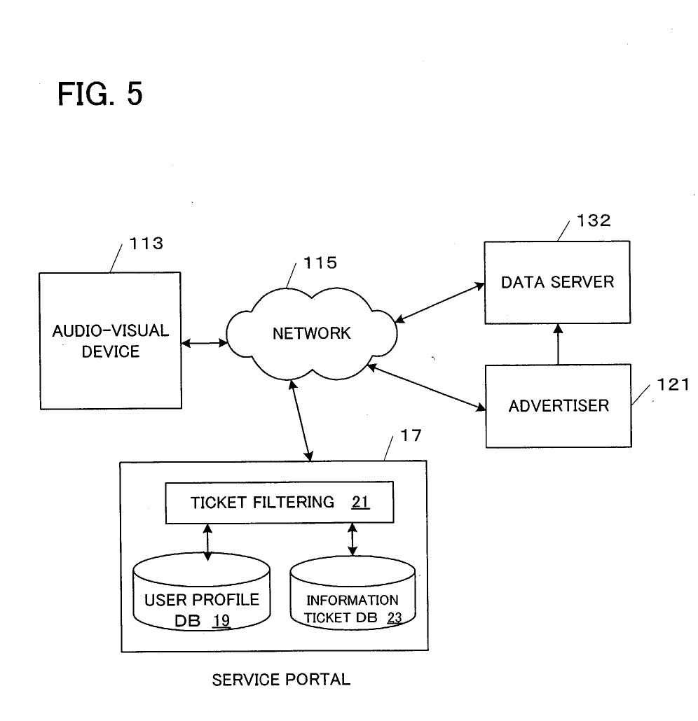

Referring now to FIG. 5, one embodiment of the present invention will be described. In the system according to this embodiment, the service portal 17 shown in FIG. 1 is used. In the example of FIG. 5, the service portal 17 comprises a user profile database 19 and an information ticket database 23. A data server or a data provider 132 provides such data as still pictures, motion pictures and music to an audio-visual apparatus 113 of a user, typically, through the Internet. These data may be provided in the form of CD, DVD or the like. Therefore, the embodiment using a network communication as shown in FIG. 5 is only one exemplary embodiment of the present invention.

An advertiser or a service provider 121 is typically a marketing company which sells services and/or commodities or an advertising company working for such marketing company on a subcontract basis. Let's assume that the data server 132 provides various still pictures to the user's audio-visual apparatus 113 through the Internet 115. The audio-visual apparatus 113 is typically a personal computer that comprises a browser to connect to the Internet. Alternatively, the audio-visual apparatus 113 may be a mobile terminal, a cell phone having a browser. When the data are provided in such form of CD and DVD, the audio-visual apparatus 113 is a CD player, a DVD player or the like. In this case, in order to use the UOI system, the user must access the service portal 17 by using a personal computer, a mobile terminal or a cell phone separately.

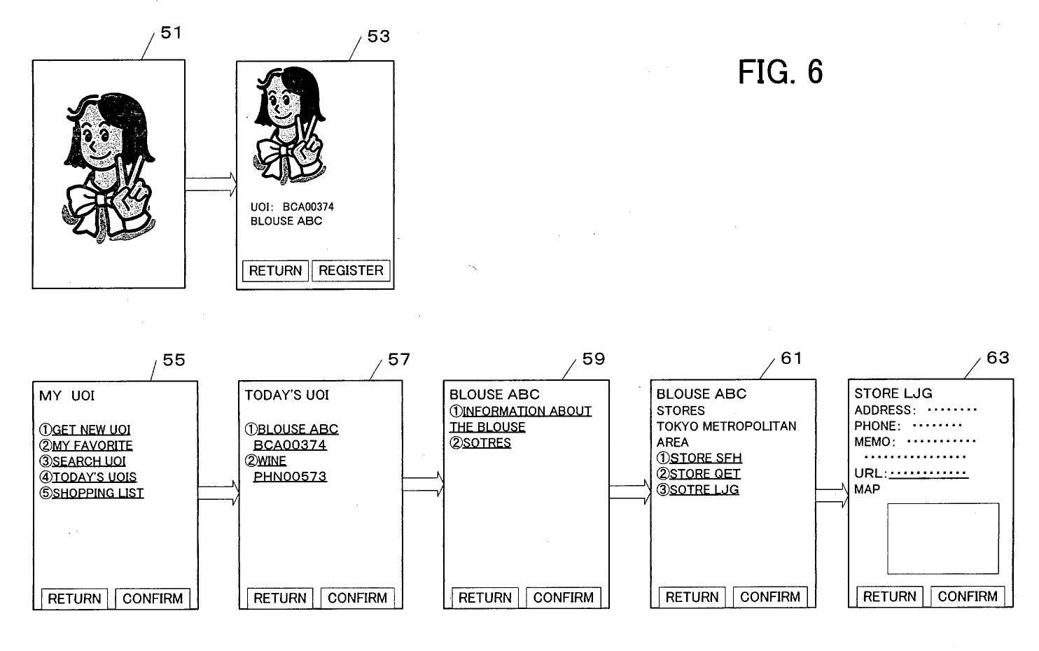

In the following discussion, the advertiser 121 is a marketing company of clothes and adds in a still picture provided by the data server 132 an advertisement for blouses it wants to sell. Referring to FIG. 6, the screen 51 displays a still picture of an actress. This screen is provided by the data server 132 over the Internet. The advertiser 121 sells blouses of the same type as the blouse that the actress wears. The advertiser 121 requests a company operating the data server 132 to embed the UOI of the blouse it sells into the screen 51.

The requested operating company adds the UOI of the blouse in an application segment field of the JPEG format within the screen 51. This field is the field in which any user of the JPEG can freely write.

The audio-visual apparatus 113 of the user who utilizes the system of this invention is able to read and display the UOI embedded within the application segment field of this still picture when a pre-determined function key is depressed while this still picture is being viewed. Similarly, the audio-visual apparatus 113 using a mouse is able to read and display the UOI when the right-hand button of the mouse is depressed while the cursor is on the still picture.

Referring to FIG. 6, the screen 53 is displayed when the user clicks the right-hand button of the mouse on the cursor put on the blouse of the actress when viewing with a personal computer, an audio-visual apparatus 113. That is, the UOI and name of the blouse which is recorded in the application segment field of the JPEG file of the picture is displayed. When a registration button is depressed (clicked) on the screen 53, the UOI is recorded in the personal computer of the user.

A screen 55 is displayed when an application program for making use of the UOI system is activated on the audio-visual apparatus 113. When “today's UOIs” in the screen 55 is clicked, a screen 57 is displayed. In this example, there are two UOIs which were been registered today. When the UOI of the blouse ABC is selected and the decision button is depressed, the audio-visual apparatus 113 is connected to the service portal through the Internet, and the user's ID and password as well as the UOI are transmitted to the service portal 17.

In response, the service portal 17 retrieves from the user profile 19 the profile of the user who transmitted the UOI. The service portal 17 further reads out the information tickets corresponding to this UOI from the information ticket database 23. In the same manner as above described with reference to FIG. 1, the service portal 17 checks the information tickets with the user profile and selects the information ticket most appropriate for the user. The user may be connected to the web site with the link included in the selected information ticket.

In this example, the information ticket is linked to a particular web page of the advertiser 121, the UOI embedded in the picture shown in the screen 51 being the one that has been added up by the advertiser 121. As for this blouse, the advertiser 121 can prepare multiple different web pages corresponding to the attributes of the users and the characteristics of the audio-visual apparatus 113 used by the user. For example, such apparatus includes cell phone, PDA or personal computer, and different versions of browsers. Thus, the advertiser may register multiple information tickets in the service portal 17. The user can be led to the most appropriate web page.

Although the UOI is embedded in the JPEG format in the above-described example, the UOI may be embedded in the screen by means of the principle of a clickable map. In one embodiment of this invention, the browser which uses the system of this invention is programmed to transmit the coordinate information of the cursor location to the server of the web site when a user clicks an object on the screen that is displayed from an HTML document. The computer program in the server providing this page is configured to register a UOI in a position of a coordinate of an object indicated in the web page. Therefore, the server can send the UOI back to the user in response to the coordinate information transmitted by the user. This way, the user can acquire the UOI of the object that is displayed on the browser.

The user can access the information associated with this UOI as above described by means of accessing the service portal 17 and transmitting this UOI there.

According to another embodiment of the present invention, an ID of the media is assigned and attached to the multimedia. This ID is the one for which the standardization process is underway by the content ID forum (CONTENT ID Forum http://www.cidf.org/) or the one which is usually represented by a barcode attached to a CD. For example, when the user obtains the UOI of a particular music program within a CD, the user may transmit the media ID of the CD together with the UOI to the service portal

The media ID can be attached as an extension of the UOI. For example, ID23456 of a CD may be transmitted in a format of JAN:123456?EmbeddedIn=CD:23456, the ID of the CD being an extension of the JAN Code123456 of the music. The media ID can be transmitted as additional information of the UOI rather than in such extension format.

In this embodiment, when the advertiser registers an information ticket, the advertiser describes in the ticket, which media is associated with the concerned ticket. For example, the advertiser may insert such comment as “Embedded in CD:23456” in the comment column for the service of the information ticket.

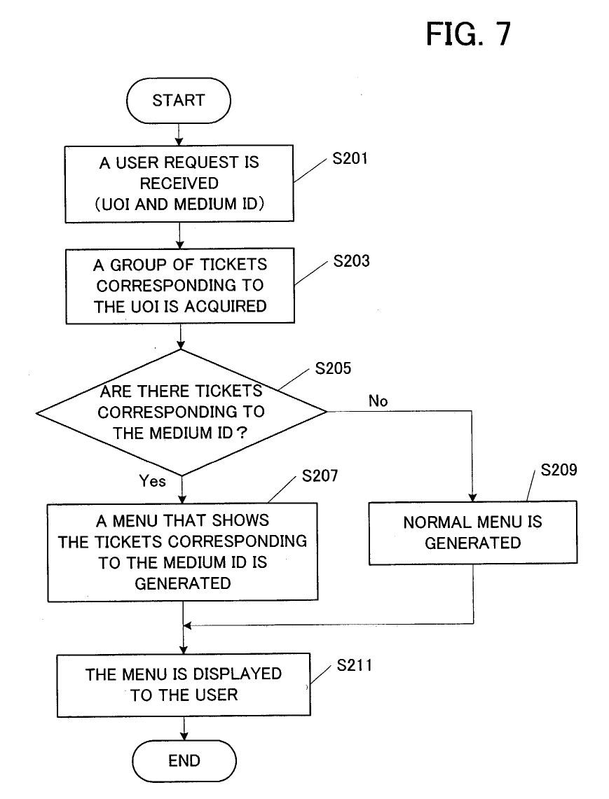

FIG. 7 is a flowchart illustrating an exemplary process in which the service portal 17 returns a menu to a user in the embodiment using the above-described media ID. The service portal 17 receives the UOI and the media ID transmitted from the user's terminal apparatus (S201) and searches the information ticket database using the UOI as a key and obtains a group of tickets corresponding to this UOI (S203). The service portal 17 determines whether or not there are tickets that are associated with the media ID in this group of tickets (S205) and, when there are any, generates a menu for preferentially presenting the information of the tickets associated with the media ID (S207). When there are no relevant tickets, a menu is generated according to a usual procedure (S209). The generated menu is transmitted and presented to the mobile apparatus of the user (S211).

Although the present invention has been described with respect to the still picture as an example, the invention is applicable to motion pictures or music as well. As for motion pictures, a UOI of an object within a motion picture can be informed to a user by means of recording the UOI in an attribute field of the MPEG format so that it may be read and displayed. Similarly, a UOI attached to a particular piece of music in a music CD can be displayed in a display panel in response to depression of a display button as long as the UOI is recorded in a control code recording field of the CD. In this case, the user accesses the service portal 17 after the user has acquired the UOI and input it to the personal computer or the like.

Besides, UOIs which are extracted from the multimedia can be distributed from a user to another user for their use. For example, it is possible for a user to capture a still picture from the video, extract a UOI of an object displayed in the still picture from the video and embed the UOI in a still picture and to transmit it to a friend via E-mail.

Although the present invention has been described with respect to some specific embodiments, the invention is not intended to be limited to those specific embodiments.

What is claimed is:

1. An information providing system comprising:
a terminal apparatus for viewing or playing contents, one or more contents being embedded with one or more identifiers, and the terminal apparatus being configured to be capable of capturing the identifier embedded in the one or more contents;
a ticket database for storing one or more information tickets associated with each of the identifiers; and
a service portal that, responsive to the identifier which is transmitted from the terminal apparatus over the Internet, searches the ticket database and provides a service to the user.

2. The system of claim 1, wherein the service portal is provided with a user profile database, and wherein the service portal, responsive to reception of a user ID and said identifier sent from a user through the terminal apparatus, retrieves the user profile of said user from the user profile database and retrieves the information tickets corresponding to said identifier from the ticket database.

3. The system of claim 2, wherein the service portal includes a ticket filtering unit for selecting one or more information tickets from the retrieved information tickets based on the user profile.

4. The system of claim 3, wherein at least one information ticket includes link information to a service provider and wherein the service portal provides the link information to the user who sent the user ID and said identifier.

5. The system of claim 3, wherein at least one information ticket includes link information to a service provider and wherein the service portal connects the user to a Web page according to the link information.

6. The system of claim 4, wherein said link information includes a URL of a Web page provided by the service provider.

7. The system of claim 3, wherein the service portal is configured to, responsive to the selected one or more information tickets, produce a menu to be presented to the user.

8. The system of claim 1, wherein said contents are provided to the user through media, and a media identifier is appended to the identifier.

9. A terminal apparatus adapted for use with a service portal that, responsive to an identifier which is transmitted from the terminal apparatus over the Internet, searches the database and provides a service, said terminal apparatus being configured to:
display or play contents obtained from a data provider that provides one or more contents to users, at least one of said contents being embedded with an identifier;
capture the identifier embedded in said at least one of said contents; and
transmit the identifier to the service portal;

10. The apparatus of claim 9, wherein the apparatus is selected from a group comprising a personal computer, a mobile computer, a audio-visual apparatus and a cell phone.

11. The apparatus of claim 10, wherein the apparatus includes a browser for viewing the service provided by or through the service provider over the Internet.
